(19) United States
(12) Patent Application Publication
(10) Pub. No.: US 2014/0363749 A1
(43) Pub. Date: Dec. 11, 2014

(54) METHOD AND SYSTEM FOR LIQUID FUEL DESULPHURIZATION FOR FUEL CELL APPLICATION

(71) Applicant: TOPSØE FUEL CELL A/S, Kgs. Lyngby (DK)

(72) Inventors: Hassan Modarresi, Lyngby (DK); Thomas Rostrup-Nielsen, Holte (DK)

(73) Assignee: Topsøe Fuel Cell A/S, Kgs. Lyngby (DK)

(21) Appl. No.: 14/365,164

(22) PCT Filed: Nov. 21, 2012
(86) PCT No.: PCT/EP2012/073171

§ 371 Date: Jun. 13, 2014

(30) Foreign Application Priority Data
Dec. 15, 2011 (DK) PA2011 00974

(51) Int. Cl. H01M 8/06

(52) U.S. Cl. CPC H01M 8/0675; H01M 8/0631
USPC 429/410

(57) ABSTRACT

A method for desulphurization of a liquid fossil fuel to be used in connection with a fuel cell is performed in a system comprising an evaporator unit (1), wherein the liquid fuel is first evaporated, a fixed bed reactor (2) in the form of a gas-phase hydro-desulphurizer, where the fuel is treated with hydrogen at atmospheric pressure over a highly active hydro-cracking (HAHT) catalyst, whereby sulphur species are converted to H2S, an adsorber (3), where the produced hydrogen sulphide can be adsorbed on a catalytic bed, and a fuel reformer (4), in which the fuel product is converted to syngas to be fed to an SOFC system (6). The evaporator unit (1) comprises a liquid spraying device, preferably in the form of a piezoelectric spray nozzle.

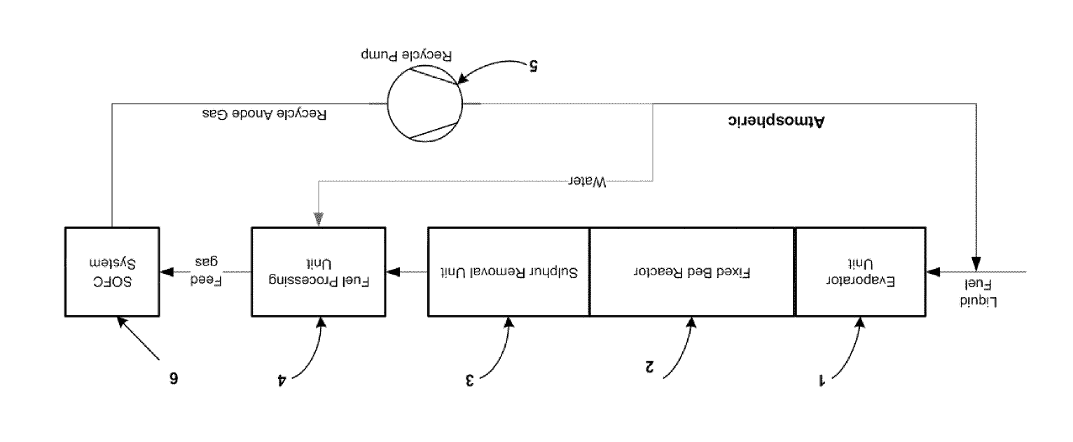

The present invention relates to a method and a system for desulphurization, preferably atmospheric desulphurization, of a liquid fossil fuel to be used in connection with a fuel cell, especially a solid oxide fuel cell (SOFC).

Conventional hydro-desulphurization (HDS), which is very common in oil refinery plants, constitutes the nearest background of the present invention. Hydroprocessing of fossil fuels to lower the sulphur content thereof has become more and more important over the recent years, as the demands to low-sulphur fuels have increased steadily. Thus, European refiners have supplied diesel and gasoline fuels with maximum 50 ppm sulphur (by weight) from 2005, and this content has further decreased to 10 ppm sulphur by 2009. Conventional HDS is continuously optimized to remove sulphur and, at the same time, to assure that the composition of the fuel is disturbed as little as possible. To aid in this optimization a continuous research within fuel catalytic cracking (FCC) has provided catalysts which enable refiners to meet future specifications for ultra low sulphur diesel and gasoline without any post-treatment.

The SOFC is an energy conversion device in which chemical energy of fuel gas is directly converted to electric energy by an electrochemical reaction. A single SOFC is able to yield a voltage of around 1 volt. Accordingly, to use the fuel cell as a power source it is necessary to construct a fuel cell system comprising a fuel cell stack in which a plurality of unit cells are connected in series with each other.

A typical SOFC system includes an SOFC stack for generating electric power, a fuel processing device for supplying hydrogen/hydrocarbon/syngas and oxygen to the stack, a power conversion system for converting DC power generated by the SOFC stack into AC power, and a heat recovery device for recovering heat generated in the SOFC.

Fuel cells can be classified in alkaline fuel cells (AFC), phosphoric acid fuel cells (PAFC), polymer electrolyte membrane fuel cells (PEMFC), molten carbonate fuel cells (MCFC) and solid oxide fuel cells (SOFC), the latter being by far the most interesting and promising class.

The purpose of fuel reforming in connection with fuel cells is to convert fuel provided as a raw material, e.g. fossil fuel, into the fuel type that the stack requires. An SOFC can use CO and also CH₄ as a fuel because of the high temperature, at which the SOFC is operated, but it is of course convenient to be able to use other types of raw fuel in the SOFC.

Logistic liquid fuel (sulphur content within the range of a few hundreds ppm by weight) desulphurization in an SOFC system is a major challenge in the system development due to ineffectiveness and inefficiency associated with unconventional non-hydrogen based and conventional hydrogen based techniques, respectively. While the conventional technique to hydro-desulphurization is effective in terms of sulphur removal, it is not an efficient approach because of the high operation pressure, which is a required condition in the trickle bed reactor. On the other hand, the unconventional non-hydrogen based technique (mainly physical adsorption at atmospheric pressure) is an efficient approach in terms of energy consumption, but not as effective as the conventional hydro-desulphurization (HDS) for sulphur removal.

The prior art comprises a number of references dealing with desulphurization of fuels. Thus, EP 1.468.463 A1 describes a method for removing sulphur from a fuel supply stream for a fuel cell, where the purpose is to produce a hydrogen-enriched fuel stream, which is used to hydrogenate the fuel supply stream. The system described in this patent application is a conventional HDS (hydro-desulphurization) unit combined with a hydrogen boosting unit.

U.S. Pat. No. 7,318,845 concerns a distillate fuel stream reformer system, in which a feed stream of fuel is first separated into two process streams, i.e. a sulphur depleted gas stream rich in aliphatic compounds and a liquid residue stream rich in aromatic compounds and sulphur. The gas stream rich in aliphatic compounds is desulphurized, mixed with steam and converted to a hydrogen-rich product stream. Reducing the amounts of sulphur and aromatic hydrocarbons directed to desulphurization and reforming operations minimizes the size and weight of the overall apparatus, and therefore the described system is well suited for fuel cell use.

US 2010/0104897 A1 discloses a fuel processing method to be performed in a solid oxide fuel cell (SOFC) system. The method comprises removing sulphur from a hydrocarbon-based fuel to obtain a hydrogen-rich reformed gas using a desulphurizer and a primary reformer, and selectively decomposing lower hydrocarbons and converting them to hydrogen and methane using a secondary reformer. This secondary reformer is merely a hydrogenation reactor, which is used to remove olefins from the reformate gas.

Other known prior art techniques for the desulphurization of liquid fuels do not seem to be useful in the foreseeable future.

It has now surprisingly turned out that a specific hydrodesulphurization, preferably an atmospheric hydrodesulphurization (AtHDS), combining the advantages of conventional hydro-desulphurization (effectiveness) and non-conventional desulphurization (efficiency), is an attractive process for application in a fuel cell system.

The invention therefore relates to a method for desulphurization, preferably an atmospheric desulphurization of a liquid fossil fuel to be used in connection with a fuel cell, especially a solid oxide fuel cell (SOFC), said method comprising the following steps:
(a) evaporation of the selected liquid fossil fuel and subsequent treatment with hydrogen in a fixed bed reactor over a catalyst, whereby sulphur species are fully/partially converted, mainly to the volatile S-species H₂S and/or COS,
(b) full or partial removal of the formed volatile sulphur species and
(c) conversion of the product to mostly syngas in a connected fuel reforming unit,

whereafter the obtained syngas is fed to an SOFC system.

The catalyst used in step (a) of the method is preferably a highly active hydro-treating (HAHT) catalyst.

The invention also concerns a system to be used for the practical working of the invention.

The drawing shows an envisaged fuel cell (here SOFC) system based on an atmospheric hydro-desulphurization unit according to the present invention.

In the fuel desulphurization system according to the invention the liquid fuel is first evaporated in an evaporator unit 1 and then treated with hydrogen in a fixed bed reactor 2, preferably at atmospheric pressure, over a catalyst, preferably a highly active hydro-treating (HAHT) or hydrocracking catalyst, where sulphur species are converted to hydrogen sulphide. Because of the high hydro-treating activity of the catalyst other (non-sulphurous) hydrocarbon chains may crack, forming small chains. This is acceptable in connection with fuel cell applications, since the molecular weight distribution of the hydrocarbon product is not important.

The evaporator unit 1 preferably comprises a liquid spraying device, such as a piezoelectric spray nozzle, which has the ability of atomizing fuel at room temperature to a very small droplet size, preferably to an average droplet size of 50 μm or less, at a temperature where the mixed vapour/gas product temperature is higher than the final boiling point of the fuel, into a hot process gas mixture comprising hydrogen and/or steam. Furthermore the evaporator unit 1 comprises an evaporation chamber designed to make fuel droplets evaporate in the gas stream before they reach the chamber walls.

In the subsequent fuel processing unit 4 the product is converted to syngas. The fuel processing unit can e.g. be a unit for catalytic partial oxidation (CPO), a steam re-former (SR) or an autothermal reformer (ATR). The syngas is fed to an SOFC system 6.

Without being limited thereto, the SOFC system 6 comprises SOFC stack(s) and any SOFC stack fuel feed gas pre- and post-treatment unit, such as an SOFC stack fuel pre-treating and an SOFC stack off-gas combustion unit.

The produced hydrogen sulphide can be adsorbed in an adsorber 3 containing a catalytic bed, for instance a ZnO bed. To improve the efficiency of the adsorption step water from the recycled gas may be condensed out and fed to the fuel reforming unit 4 by means of a recycling pump 5.

In a fuel cell system like the system according to the invention the power consumption of the recycling compressor is trivial due to the low pressure operation. Since the reactor is of the two-phase (solid/gas) type, there is no significant mass transfer resistance in the fluid phase.

As mentioned above, conventional HDS is optimized to remove sulphur while only disturbing the composition of the fuel to a negligible extent. However, as the fuel in a fuel cell system after the desulphurization typically is reformed to form methane, then CO, CO₂ and H₂ are not necessary to protect the fuel composition. Therefore, a better alternative to HDS would be the more aggressive hydro-treating, which still liberates the sulphur, but which can be carried out in a smaller reactor system under milder reaction conditions (i.e. requirements to a very low hydrogen partial pressure).

Technically, the HDS reactor is a three-phase trickle bed reactor. In the reactor a layer of liquid fuel covers the solid catalyst particles. Gaseous reactants (in this case hydrogen gas and light hydrocarbons) are to dissolve in the liquid phase, move to the catalyst surface and react with liquid reactants on the active sites of the catalyst. For such a reaction system solubility could be the limiting factor for the reaction rate. Under typical HDS reaction conditions (elevated pressure and temperature) the solubility of hydrogen in the liquid phase amounts to a few percents, whereas under atmospheric pressure it is as low as a few hundred ppm. That is the reason why a conventional HDS unit cannot be utilized in a fuel cell system operating at atmospheric pressure. In the present AtHDS system the necessity for a high pressure reactor is eliminated.

The following example illustrates the invention further.

### EXAMPLE

A sample of NiMo hydro-cracking catalyst comprising 7-18% molybdenum trioxide on aluminium oxide was sulphidated with hydrogen sulphide and used as AtHDS catalyst. Jet fuel JP-8 with a sulphur content of 270 ppm by weight was sprayed into a hot gas mixture of 10% hydrogen and 90% nitrogen at 300-320° C. and passed over the catalyst with a GHSV (gas hourly space velocity) of 1500-2000 1/hr. The outlet vapour/gas mixture from the reactor was immediately cooled down to room temperature, and the liquid and gas streams were separated. The sulphur content of the liquid phase was analysed using an EDXRF (D7212) for total sulphur. The processed fuel sulphur content was measured to be 93 ppm by weight.

1. A method for desulphurization of a liquid fossil fuel to be used in connection with a solid oxide fuel cell (SOFC) system, said method comprising the following steps:
(a) evaporation of the selected liquid fossil fuel in an evaporator unit comprising a liquid spraying device, which has the ability of atomizing fuel at room temperature to a very small droplet size into a hot gas mixture comprising hydrogen and/or steam, preferably a piezoelectric spray nozzle with the ability of atomizing fuel at room temperature to a very small droplet size, and subsequent treatment with hydrogen in a fixed bed reactor over a catalyst, whereby sulphur species are fully/partially converted, mainly to the volatile sulphur species H₂S and/or COS,
(b) full or partial removal of the formed volatile sulphur species and
(c) conversion of the product to mostly syngas in a connected fuel reforming unit,
where the evaporation of the selected liquid fossil fuel and subsequent catalytic treatment with hydrogen in a fixed bed reactor in step (a) is conducted at a pressure below 5 bar (abs), preferably below 2 bar (abs) and most preferred close to ambient pressure, whereafter the obtained syngas is fed to the SOFC system.

2. Method according to claim 1, wherein the catalyst is a highly active hydro-treating (HAHT) catalyst.

3. A system for the desulphurization of a liquid fossil fuel by the process according to claim 1, said system comprising:
an evaporator unit (1), wherein the liquid fuel is first evaporated, a fixed bed reactor (2) in the form of a gas-phase hydro-desulphurizer, where the fuel is treated with hydrogen at atmospheric pressure over a highly active hydro-cracking/hydro-treating catalyst, whereby sulphur species are converted to H₂S, an adsorber (3), where the produced hydrogen sulphide can be adsorbed on a catalytic bed, and a fuel reformer (4), in which the fuel product is converted to syngas to be fed to an SOFC system (6).

4. System according to claim 3, wherein the evaporator unit (1) comprises an evaporation chamber designed to make fuel droplets evaporate in the gas stream before they reach the chamber walls.

5. System according to claim 4, wherein the spray nozzle in the evaporator unit (1) atomizes fuel to an average droplet size below 1000 μm, preferably below 100 μm.

6. System according to claim 3, further comprising a recycling pump (5) to improve the adsorption efficiency by condensing out water from the recycled gas and feeding it to the fuel reforming unit (4).

7. System according to claim 3, wherein the fuel processing unit is a unit for catalytic partial oxidation, a steam reformer or an autothermal reformer (ATR).

8. System according to claim 3, wherein the SOFC system (6), without being limited thereto, comprises SOFC stack(s) and any SOFC stack fuel feed gas pre- and post-treatment unit, such as an SOFC stack fuel pre-treating and an SOFC stack off-gas combustion unit.

9-11. (canceled)
